(19) United States
(12) Patent Application Publication
(10) Pub. No.: US 2020/0040571 A1
(43) Pub. Date: Feb. 6, 2020

(54) MOVABLE SCREEN

(71) Applicant: PROTEZIONI S.R.L, Veglie (LE) (IT)

(72) Inventor: Sara Milo, Veglie (LE) (IT)

(73) Assignee: PROTEZIONI S.R.L., Veglie (LE) (IT)

(21) Appl. No.: 16/482,439

(22) PCT Filed: Mar. 1, 2018
(86) PCT No.: PCT/IB2018/051311

§ 371 Date: Jul. 31, 2019

(30) Foreign Application Priority Data
Mar. 6, 2017 (IT) 102017000024060

(51) Int. Cl. E04B 2/74; E04F 11/18; E04H 17/16

(52) U.S. Cl. CPC E04B 2/7424; E05Y 2800/122; E04H 17/165; E04F 11/1853

(57) ABSTRACT

A screen for realizing partitions for outdoor use, comprising a fixed bottom element; an intermediate element vertically sliding to said first fixed element between a first position, in which it projects almost completely in vertical direction to said first fixed element, and a second position, in which it is lowered up to overlap, in front view, to said first fixed element; a terminal movable element vertically sliding to said intermediate element between a first position, in which it projects almost completely, and a second position, in which it is overlapped, in front view, to said intermediate element, each one of said elements comprising a transparent panel, a frame made up of a couple of vertical uprights, characterized in that the vertical uprights of said first fixed element comprise a through vertical recess, facing the screen center and such shaped and dimensioned that it houses the section bars of the intermediate element in sliding manner, and the vertical uprights of said intermediate element comprise a through vertical recess, facing the screen center and such shaped and dimensioned that it houses the section bars of the terminal element in sliding manner.

### BACKGROUND OF THE INVENTION

The present invention relates generally to a movable screen provided with an automatic coupling system.

### TECHNICAL FIELD

### 1. Field of the Invention

At the state of the art there are known many embodiments of screen structures. They are generally vertical structures, typically installed outdoor, which allow a barrier to the wind to be realized and which are preferably transparent so that they do not represent a visual obstacle.

### 2. Brief Description of the Prior Art

In the Italian application MI2010A001060 it is described a modular screen, which comprises a bottom element, intended to keep the screen element upright and an upper element, which can be lifted and lowered to the basic element. The bottom element and the upper element are made up of a frame with two uprights and two crosspieces enclosing a transparent panel, and the upper element uprights are housed by sliding in the lower element uprights by means of respective gas springs. The upper element uprights are made up of section bars whose outer outline corresponds perfectly to the inner outline of ai corresponding seat provided in the lower element upright.

Another embodiment marketed by Aluminco consists in a movable screen comprising a lower base and an upper element, which is movable by sliding to the same and which is provided with a frame made up of uprights only, without stiffening crosspieces.

Yet, another embodiment is described in the Patent application for utility model ITPR20040010, in which it is described a screen with a latch system where the upper panel, which slides to the lower panel, is moved by means of a crank installed on one of the crosspieces of the lower element frame. Other embodiments, substantially similar to the just described ones, are known on the market (produced for example by Durasol Awnings, Plateatico and Glasscon).

According to the knowledge of the present applicant, all the screens known at the state of the art comprise no more than two elements, one of which being movable in vertical direction only, and which are provided with various actuation systems (typically spring or crank systems).

### SUMMARY OF THE INVENTION

Aim of the present invention is to provide a movable screen for outdoor use, which can be folded when not used in order to make its dimensions and aesthetic impact lower to the known, embodiments; which can be lifted up to a height useful to protect the area intended to be sheltered from the wind; which has a very low frame visual impact (and in particular, which does not provide the use of crosspieces but of uprights only), and which allows very safe and easy lifting and lowering operations of the screen movable portions.

Concerning the possibility to fold the screen as much as possible, aim of the present invention is to provide a movable screen provided with a fixed element and two movable elements, which slide vertically to the fixed element.

Concerning the visual impact reduction, aim of the present invention is to provide a movable screen provided with a fixed element and two movable elements, which slide vertically to the fixed element, in which each element comprises a transparent panel constrained by a frame made up of two vertical uprights.

According to another aim, concerning the lifting and lowering operations, aim of the present invention is to provide a movable screen in which each one of the two movable elements is movable between a first and a second position, in which each one of said movable elements remains stable both in said first and second position without needing user interventions and in which said movable elements lifting occurs without user efforts but by means of a gas spring.

In particular, it is to be said that in order to reach the last aim it is needed that the movable screen is provided with a suitable automatic coupling and de-coupling system, (whose functioning is described in detail in the following) which allows to lock and release the movable elements by means of a simple action when they are in their lowered position (a position in which they are subjected anyway to the action of the gas spring, which would tend to lift them).

The present invention reaches the prefixed aims since it is a screen for realizing partitions for outdoor use, comprising: a fixed bottom element (10); an intermediate element (20) vertically sliding to said first fixed element (10) between a first position, in which it projects almost completely in vertical direction to said first fixed element (10), and a second position, in which it is lowered up to overlap, in front view, to said first fixed element (10); a terminal movable element (30) vertically sliding to said intermediate element (20) between a first position, in which it projects almost completely, and a second position, in which it is overlapped, in front view, to said intermediate element (20), each one of said elements (10, 20, 30) comprising a transparent panel (11, 21, 31), a frame made up of a couple of vertical uprights (12, 22, 32), characterized in that the vertical uprights (12) of said first fixed element (10) comprise a through vertical recess (122), facing the screen center and such shaped and dimensioned that it houses the section bars (22) of the intermediate element (20) in sliding manner, and the vertical uprights (22) of said intermediate element (20) comprise a through vertical recess (223), facing the screen center and such shaped and dimensioned that it houses the section bars (32) of the terminal element (30) in sliding manner.

These and other advantages will be clear by the detailed description of the invention, which will refer to the appended FIGS. 1 to 12.

### BRIEF DESCRIPTION OF THE DRAWINGS

FIG. 1 shows an axonometric view of the screen according to the present invention, in completely lifted configuration; FIG. 2 shows a view of a partially lifted configuration of the screen; FIG. 3 shows a completely lowered configuration.

FIG. 4 snows an exploded view of the screen, in which three panels and respective fittings are shown disassembled to each other; FIGS. 5, 6 and 7 show exploded views of the single panels;

FIG. 8 shows an axonometric view of the panel in its completely lowered configuration, in which the elements shown in phantom allow to individuate the position of the coupling and decoupling systems; The devices allowing automatic panels coupling and decoupling are; shown in FIGS. 9 and 10, and their functioning is shown in FIG. 11.

FIG. 12 shows a section view of each one of the section bars used to realize the screen according to the invention; FIG. 13 shows a section view of the assembled section bars and highlights the transparent panels position.

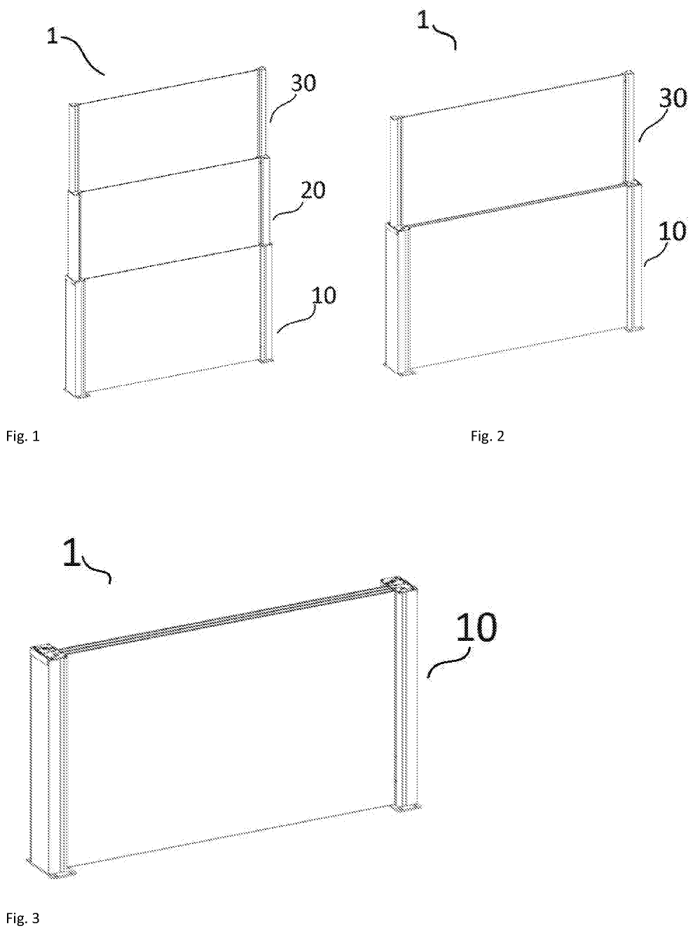

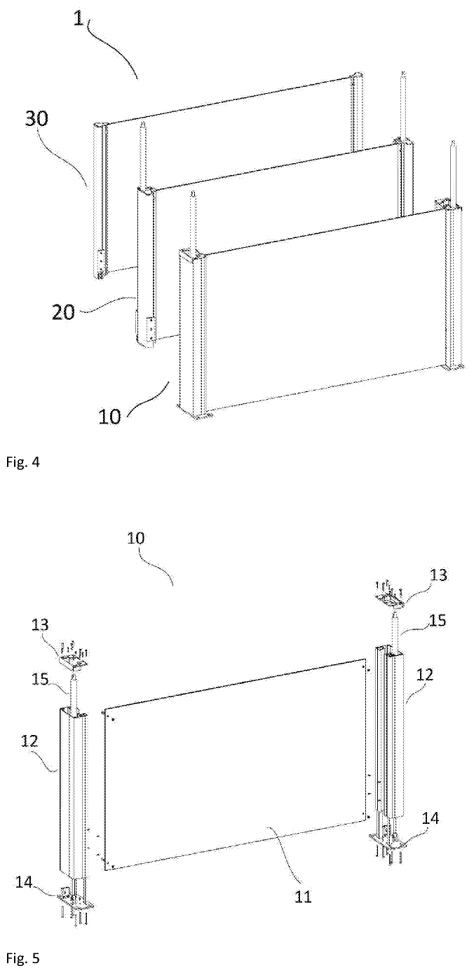

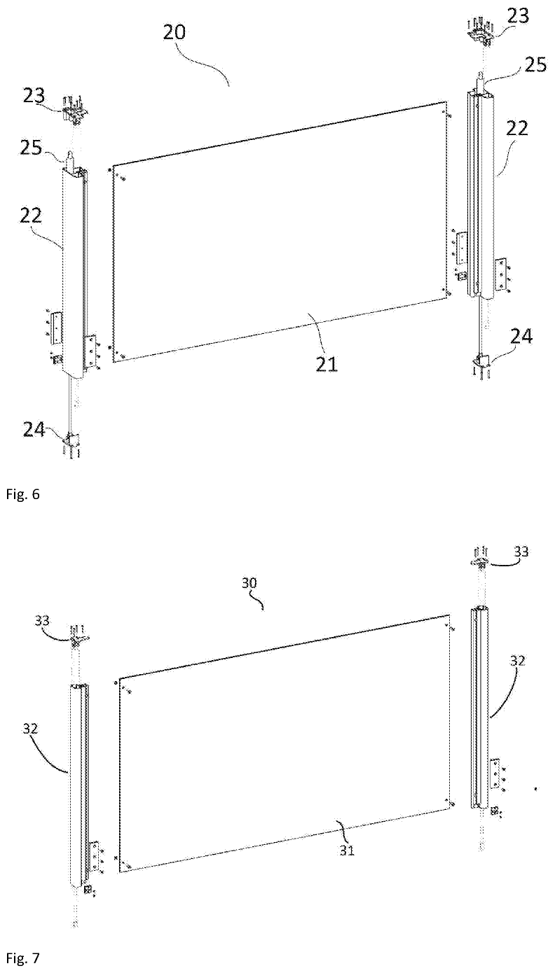

With reference to the appended FIG. 1, it is observed that the screen (1) according to the invention comprises a fixed bottom element (10) and two movable elements (20, 30) vertically sliding to said first fixed element (10).

The intermediate element (20) slides between a first position (shown in FIG. 1), in which it projects almost completely in vertical direction to said first fixed element (10), and a second position (shown in FIG. 2), in which it is lowered up to overlap, in front view, to said first fixed element (10).

As it is shown in FIGS. 2 and 3, the terminal movable element (30) can slide to said intermediate element (20) between a first position, in which it projects almost completely, and a second position, in which it is overlapped, in front view, to said intermediate element (20).

FIG. 4 shows the elements (10, 20, 30), which make up the screen, in exploded view.

As it can be seen in FIG. 5, the fixed element (10) comprises a transparent panel (11) constrained to a frame made up of two profiled vertical uprights (12). Said uprights (12) are provided with lower constraining plates (14) for fixing to the ground and upper plugs (13) closing partially the upper portion outline. Inside the uprights there are also provided gas springs (15) configured to lift the intermediate element (20).

### DETAILED DESCRIPTION OF THE PREFERRED EMBODIMENTS

The section bars (12) of the vertical uprights of the fixed element (10) comprise a housing (121) to house the transparent panel (11) and a through vertical recess (122), which is parallel to said housing, facing the screen center and such shaped and dimensioned that it houses the section bars (22) of the intermediate element (20) in sliding manner. The gas spring's (15) are positioned vertically inside said through recess and are configured so that they exert their force between the lower plates (14) and the intermediate element (20).

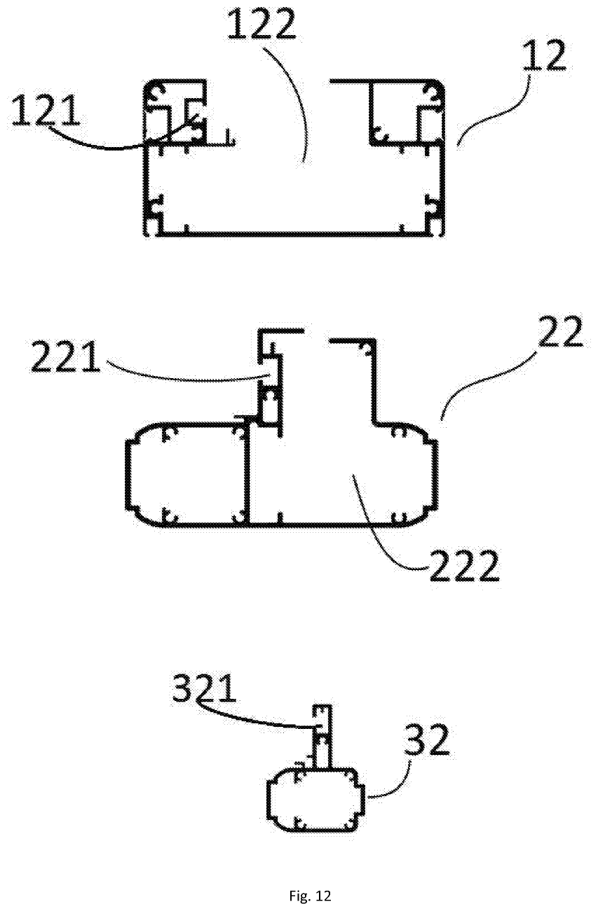

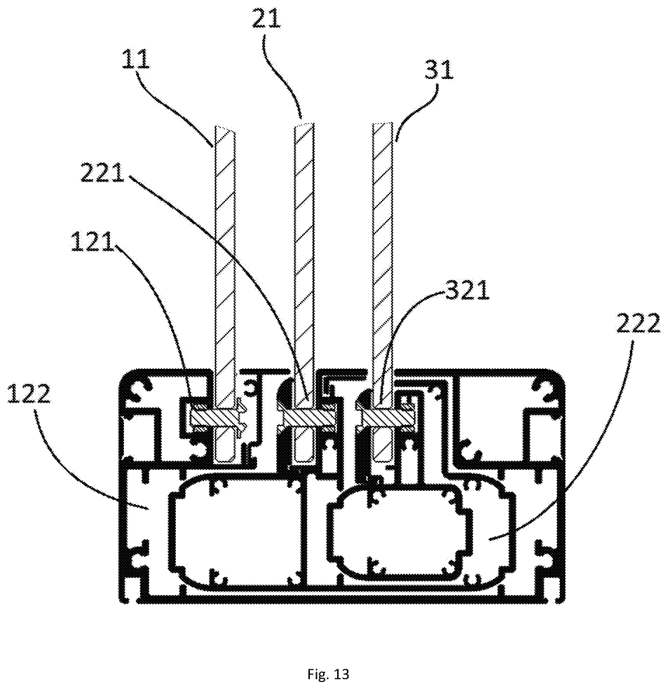

As it is clear from the appended FIGS. 12 and 13, the housing (121) of the transparent panel is configured so that it houses the panel fixing screws, which, in addition to the section view of FIG. 13, are visible also in the exploded view of FIG. 5, and which engage through holes provided on the panel. Bushings, as it is shown in FIG. 5, can be possibly used for fixing the screws, or the screws can be threaded directly in the upright. As it is shown in FIG. 12, a flat abutting surface, which is parallel to the transparent panel plane, and against which the glass is pushed by clamping the screws, is provided immediately near and on both sides of the opening of the housing (121), in order to allow the panel constraint.

This measure allows to fix the panel integrally only by using vertical uprights, as it is shown in FIG. 5, contrary to what happens in the devices described in documents of prior art (as for example document EP2395167), where since the glass is siliconized inside the panels, it is needed the use of a frame comprising four uprights, two vertical and two horizontal ones, which is less attractive aesthetically.

The intermediate element (20) slides to said fixed element (10) as it is described in the following. The intermediate element (20) comprises a transparent panel (21) constrained to a frame made up of two profiled vertical uprights (22). Said uprights (22) are provided with lower plugs (24) for closing the section bar in the lower portion and upper plugs (23) closing partially the outline of the upper portion. Inside the uprights (22) there are also provided gas springs (25) configured to lift the upper element (30). The section bars (22) of the vertical uprights comprise a housing (221) for the transparent panel (21) and a through vertical recess (222), parallel to said housing, facing the panel center and such shaped and dimensioned that it houses the outline of the terminal element (30) in sliding manner. The gas springs (25) are positioned vertically inside said through recess and are configured so that they exert their force between lower plugs (24) and the terminal element (30). The outer profile of the uprights (22) is such that it can be housed slidingly inside the recess (122) provided in the uprights (12) of the fixed element (10).

The terminal element (30) slides to the intermediate element (20), as it is described in the following. The terminal element (30) comprises a transparent panel (31) constrained to a frame made up of two profiled vertical uprights (32).

Said uprights (32) are provided with upper plugs (33) closing completely the outline of the upper portion. The section bars (32) of the vertical uprights comprise a housing (321) for the transparent panel (31). The outer profile of the uprights (32) is such that it can be housed slidingly inside the recess (222) provided in the uprights (22) of the intermediate element (20).

The shape of all the section bars is shown in section in the appended FIG. 12. FIG. 13 shows the section bars assembled.

After describing all the elements provided in the screen according to the invention, it is now possible to describe their functioning.

When the screen is in completely lifted position, as it is shown in FIG. 1, the forces exerted by the gas springs (15, 25) are such that they keep the intermediate element (20) and the terminal element (30) stably in position. To such aim, each one of the two springs is set conveniently to exert a slightly higher force than the weight it has to withstand.

Passing now from the completely lifted configuration of FIG. 1 to the intermediate configuration of FIG. 2, it is sufficient to apply a vertical force downwards to the intermediate panel (20), up to bring the intermediate element in the position, of FIG. 2. In this position the intermediate element (20) remains automatically constrained thanks to the automatic coupling system (whose functioning is described in detail in the following).

From this position, in order to lift again the intermediate element (20) it is sufficient to exert a new force downwards so that the coupling system is released, and to allow that the force of the gas spring (15) brings the element (20) again in completely open position.

The terminal element (30) has an analogous functioning. From the partially lifted configuration shown in FIG. 2, in order to pass to the completely lowered configuration of FIG. 3, it is sufficient to exert a force downwards on the terminal element, up to bring it in the position of FIG. 3, in which the terminal element remains automatically locked.

From this position, in order to lift the terminal element (30) again it is sufficient to exert a force downwards again so that the element is slightly lowered, the coupling system is released, and the gas spring (25) force is allowed to bring again the terminal element (30) in completely open position.

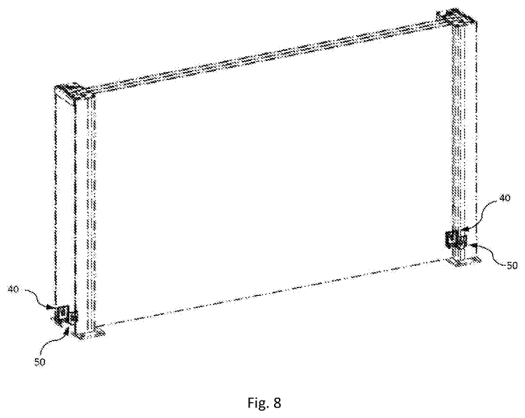

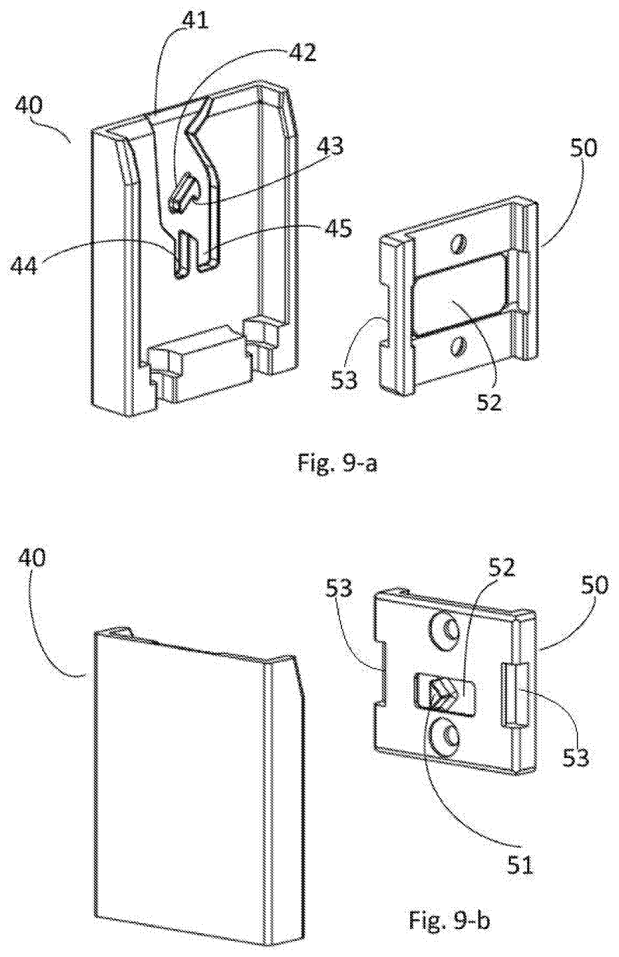

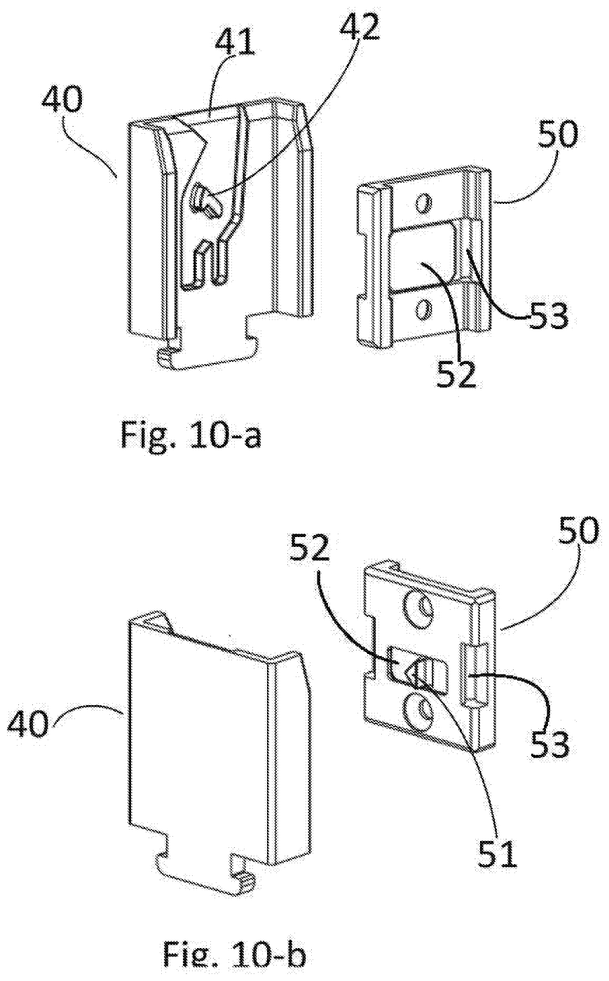

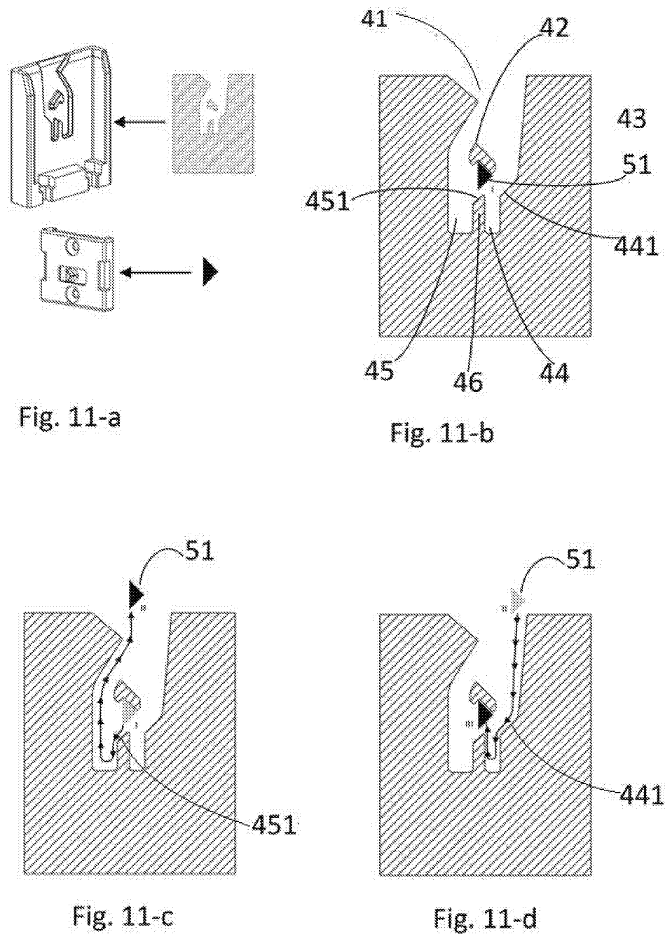

The functioning of the coupling system is shown in FIGS. 8 to 11. FIG. 8 shows the position of the constraining system inside the section bars. As it is shown in FIG. 9, the constraining system is made up o a fixed plate (40) and a movable plate (50).

The fixed plate (40) is “C” shaped, and is provided with a shaped recess (41) positioned on the central side of the plate and facing the center of the same, described in detail in the following. Inside the recess (41) it is provided a stop element (42) provided with a concavity (43) facing downwards. The movable plate (50) is configured so that it can slide vertically inside the two sides of the “C” section of the fixed plate (40). Moreover, the movable plate (50) is provided with a slider (52) provided with a projection (51) with triangular section. The slider (52) is such shaped and dimensioned that said triangular projection (51) slides horizontally inside a through recess (53) provided on the movable plate (50).

The fixed (40) and the movable plate (50) are configured such that, when said triangular projection (51) is engaged in said concavity (43), after a movement downwards of the movable plate (50), the projection (51) is translated in horizontal direction so that it can slide upwards in the following without engaging again in said concavity (43).

In addition, the plates are configured so that, when said movable plate (50) slides upside down to said fixed plate (40), said triangular projection (51) is translated horizontally such that it engages in said concavity (43) in the next movement upwards.

The fixed and movable plates are constrained to elements which slide to each other: in a first coupling the fixed plate (40) is constrained to the upright of the fixed element (10) at the closing plate (14) and the movable plate (50) is constrained in the lower portion to the upright of the intermediate element (20); in a second coupling the fixed plate (40) is constrained to the upright (22) of the intermediate element (20) at the closing plate (24) and the movable plate (50) is constrained to the lower portion of the upright (32) of the terminal element (30). In any case, the plates are mounted so that the triangular projection (51) of the slider (52) of the movable plate (50) faces the fixed plate (40).

With reference to FIG. 11-b, it is to be noted that the recess (41) of the fixed plate is shaped so that in the lower portion it has a first (44) and a second channel (45) separated by a partition (46). In the upper portion of the channels (44, 45) there are provided oblique surfaces (441, 451). Inside the recess it is also provided a stop element (42), shaped as a hook with the concavity (43) facing downwards.

In locked system position, the movable plate is in the position schematized in FIG. 11-b, with the projection (51) locked in the concavity (43) of the hooked stop element (42). The force of the gas spring pushes the movable plate—which is constrained to the intermediate element (20) or the terminal element (30)—upwards and avoids the movable plate movement.

By moving the movable plate; downwards, the oblique surface (451) invites the projections (51) in the second vertical channel {45}. It is to be remembered that the movable plate can. slide horizontally to the fixed plate.

When the outer force, which pushes the movable plate downwards, ends the gas spring moves upwards the element, which the movable plate (50) is integral to. By virtue of the horizontal translation the movable plate (50) is subjected to while moving downwards, the projection (51) is no more locked by the hooked element (42) and can go upwards, as it is shown by the arrows in FIG. 11-c.

This allows to lift the intermediate element (20) to the fixed element (10) automatically—or the terminal element (30) to the intermediate element (20).

If it is intended to bring again the elements in closed position, it is sufficient to exert a force downwards. The path of the movable plate (50) is shown by the arrows in FIG. 11-d. I this case, the oblique surfaces invite the projection (51) inside the first vertical channel (44). When the force downwards ends the springs push again upwards the projection (51) which, in this case, will be locked in the concavity (43) of the hooked element (42). Practically, this is the starting position again, starting from which the functioning of the two plates has been described.

In this way the automatic coupling of the terminal element (or intermediate element) is obtained by means of a simple application of force downwards. Preferably, but non limitingly, when the device is mounted to delimit a space (as for example dehors of a bar or a restaurant), the mounting direction is such that the transparent panel (31) of the terminal module (30) is outside the panel (21) of the intermediate module (20), which in turn, is outside the fixed panel (11). Obviously, inner means the side facing the delimited space and outer means the side opposed thereto.

In this way, rain pouring on the terminal module or intermediate module cannot drip inside the delimited space, but only outside.

It is to be precised that the screen (1) described and shown in the figures is to be intended as a modular element useful for realizing partitions for outdoor use, comprising a plurality of screens (1) arranged side by side and/or angularly, according to the particular mounting needs.

It is also to be specified that even if in the figures the panels (11, 21, 31) are always shown flat, the screen (1) according to the invention can be realized, without any variation of the described mechanism, with angular panels, preferably comprising two surfaces arranged orthogonally therebetween.

Yet, another embodiment consists in realizing parapets or balustrades by using side by side one or more devices according to the invention. To such aim. the uprights of the fixed module can be conveniently dimensioned to withstand loads, which parapets and balustrades are to be checked to.

1. A screen (1) for realizing partitions for outdoor use, comprising:
a fixed bottom element (10);
an intermediate element (20) vertically sliding to said first fixed element (10) between a first position, in which it projects almost completely in vertical direction to said first fixed element (10), and a second position, in which it is lowered up to overlap, in front view, to said first fixed element (10);
a terminal movable element (30) vertically sliding to said intermediate element (20) between a first position, in which it projects almost completely, and a second position, in which it is overlapped, in front view, to said intermediate element (20),
each one of said elements (10, 20, 30) comprising a transparent panel (11, 21, 31) fixed to a frame made up of a couple of vertical uprights (12, 22, 32),
characterized in that
each one of said uprights (12, 22, 32) comprises a housing (121, 221, 321) configured to allow coupling by means of screws of said transparent panel (11, 21, 31) and a flat abutting surface, adjacent from both sides to said housing (121, 221, 321) and positioned in parallel direction to the transparent panel one,
and in that
the vertical uprights (12) of said first fixed element (10) comprise a through vertical recess (122), facing the screen center and such shaped and dimensioned that it houses the section bars (22) of the intermediate element (20) in sliding manner, and the vertical uprights (22) of said intermediate element (20) comprise a through vertical recess (223), facing the screen centre and such shaped and dimensioned that it houses the section bars (32) of the terminal element (30) in sliding manner.

2. The screen (1) for realizing partitions for outdoor use according to claim. 1, comprising a first and a second couple of gas springs (15, 25), respectively arranged inside the section bars (12, 22) of said tixed element (10} and said intermediate element (20),
said first couple of gas springs (15) being positioned vertically inside said through recess (122) and being configured so that it exerts its own force between the lower closing plates (14) of the section bar (12) of the fixed element (10) and the closing plate (23) of the intermediate element (20),
and said second couple of gas springs (25) being-positioned vertically inside said through recess (222) and configured such that it exerts its force between the lower closing plugs (24) of section bars (22) of the intermediate element (20) and the closing plate (33) of the terminal element (30).

3. The screen (1) according to claim 2, further comprising an automatic constraining and coupling system of said terminal element (30) to said intermediate element (20), said constraining system comprising a fixed plate (40) integral to said intermediate element (20), and a movable plate (50) integral to said terminal element (30), said movable plate (50) being provided with a slider (52) provided with a projection with triangular section (51} horizontally sliding inside a through recess (53) provided on the movable plate (50), and characterized in that
said fixed plate comprises a shaped recess (1) and a stop element (42) provided with a concavity (43) facing downwards, said shaped recess (41) and said triangular projection (41) being configured so that, when said triangular projections (51) is engaged in said concavity (43), after a movement downwards of the movable plate (50), the projection (51) is translated horizontally so that it can slide upwards in the following without engaging again i said concavity (43).

4. The screen (1) according to claim 3, wherein said shaped recess (41) and said triangular projection (51) are also configured so that, when said movable plate (50) slides upside down to said fixed plate (40), said triangular projection (51) is translated horizontally so that it engages in said concavity (43) in the next movement upwards.

5. The screen (1} according to claim 4, further comprising an automatic constraining and coupling system of said intermediate element (20) to said fixed element (10), said constraining system being made up similarly to the constraining system provided between said terminal element (30) and said intermediate element (20).

6. The screen (1) according to claim 1, wherein said transparent panels (11, 21, 31) are flat.

7. The screen (1) according to claim 1, wherein said transparent panels (11, 21, 31) are angular panels.

8. A partition for outdoor use comprising a plurality of screens (1) according to claim 1, arranged side by side and/or angularly according to mounting needs.

9. A parapet comprising a plurality of partitions according to claim 8.
